(19) United States
(12) Patent Application Publication
(10) Pub. No.: US 2014/0001385 A1
(43) Pub. Date: Jan. 2, 2014

(54) Adjustable Solenoid-Operated Directional Valve

(71) Applicant: Micheal Neil Scott, Keller, TX (US)

(72) Inventor: Micheal Neil Scott, Keller, TX (US)

(21) Appl. No.: 13/465,038

(22) Filed: Jun. 30, 2012

(51) Int. Cl. F16K 31/02

(52) U.S. Cl. 251/129.15

(57) ABSTRACT

Apparatus and methods move a rod via a solenoid. A solenoid moves an armature and compresses a spring when the solenoid is energized. The armature moves in response to the energization of the solenoid and couples with the rod, which transfers motion to a working portion. A stroke limiter limits movement of the first armature within the first solenoid when the solenoid is energized. The stroke limiter comprises a surface with a first portion limiting the movement of the armature, a second portion adjustably coupling the stroke limiter to the solenoid thereby setting a stroke length, the second portion releasably coupling the stroke limiter to a fastener, a third portion allowing for adjustment of the position of the stroke limiter and being shaped to fit an adjusting member. The fastener secures the stroke limiter in place with respect to the solenoid and maintaining the stroke length.

### FIELD

The invention disclosure relates to solenoids constructed to open and close valves with adjustable flow.

### BACKGROUND

A solenoid is a device that converts energy into linear motion. A solenoid valve is an integrated device containing an electromechanical solenoid which actuates either a pneumatic or hydraulic valve, or a solenoid switch. Solenoid valves are the frequently used control elements in fluidics to shut off, release, dose, distribute or mix fluids. Solenoids offer fast and safe switching, high reliability, long service life, good medium compatibility of the materials used, low control power and compact design.

Electromechanical solenoids include an electromagnetically inductive coil, wound around a movable slug or armature. The coil is shaped to allow the armature to move in and out of the center of the coil to convert the energy applied to the coil into movement of the armature. Controlling the movement of the armature within the coil allows for controlling the linear motion of whatever is coupled to the armature.

### SUMMARY

In one embodiment, an apparatus for limiting the movement of an armature of a solenoid may include a first solenoid having a first casing and first windings positioned within the first casing; a first armature within the first solenoid and movable in a first direction toward a center of the windings when the first solenoid is energized; a first rod attached to the first armature; one of a poppet and a spindle attached to the rod and configured to engage an opening in a valve such that the first armature moves the one of a poppet and a spindle away from the opening when energized; a first spring configured to urge the first armature in a direction away from the center of the first windings such that the rod moves the one of a poppet and a spindle to engage the opening; and a first stroke limiter adjustably positionable relative to the first windings and configured to engage the first armature, whereby travel of the first armature toward the center of the windings in response to energizing the windings can be varied to limit travel of the first armature and the one of a poppet and a spindle from the opening to a preset distance.

In another embodiment, an apparatus for limiting the movement of an armature of a solenoid may include a first solenoid having a first casing and first windings positioned within the first casing; a first armature within the first solenoid and movable in a first direction toward a center of the first windings when the first solenoid is energized; a first rod attached to the first armature; a second solenoid having a second casing and second windings; a second armature within the second solenoid and movable in a second direction toward a center of the second windings when the second solenoid is energized; a second rod attached to the second armature; a spindle attached to the first and second rods and configured to engage an opening in a valve such that the first armature moves the spindle in a first direction when the first windings are energized, and the second armature moves the spindle in a second direction when the second windings are energized; a first stroke limiter adjustably positionable relative to the first windings and configured to engage the first armature, whereby travel of the first armature toward the center of the first windings in response to energizing the first windings can be varied to limit travel of the first armature and the spindle from the opening to a preset distance; and a second stroke limiter adjustably positionable relative to the second windings and configured to engage the second armature, whereby travel of the second armature toward the center of the second windings in response to energizing the second windings can be varied to limit travel of the second armature and the spindle from the opening to a preset distance.

In yet another embodiment, a method for limiting the movement of an armature of a solenoid may include providing a first solenoid configured to displace a first armature connected to a first rod in a first direction; connecting one of a poppet and a spindle to the rod, to engage an opening in a valve in response to displacement of the armature; adjusting a first stroke limiter to limit movement of the first armature within the first solenoid to a first preset distance when the first solenoid is energized; and energizing the first solenoid to displace the first armature the first preset distance within the first solenoid, thereby displacing the one of the poppet and the spindle relative to the opening in the valve.

Other objects and advantages of the disclosed method and apparatus for limiting the movement of an armature of a solenoid will be apparent from the following description, the accompanying drawings and the appended claims.

### BRIEF DESCRIPTION OF THE DRAWINGS

Several drawings are included for the understanding of the subject matter sought to be patented. Below is a brief description of the several views of the drawings. The detailed description refers to the different views by specifying the numbers of the figures, and to the different parts by use of reference letters or numerals.

FIG. 1A is a cutaway diagram of an embodiment of the disclosed apparatus for limiting the movement of an armature of a solenoid, in the form of a single solenoid single valve controller when the solenoid is not energized and adjusted for higher flow.

FIG. 1B is a cutaway diagram of the controller of FIG. 1A, shown when the solenoid is energized and adjusted for higher flow.

FIG. 1C is a cutaway diagram of the controller of FIG. 1A, shown when the solenoid is not energized and adjusted for lower flow.

FIG. 1D is a cutaway diagram of the controller of FIG. 1A, shown when the solenoid is energized and adjusted for lower flow.

FIG. 2A is a cutaway diagram of another embodiment of the disclosed apparatus for limiting the movement of an armature of a solenoid, in the form of a single solenoid multiple port valve controller, shown when the solenoid is not energized.

FIG. 2B is a cutaway diagram of the controller of FIG. 2A, shown when the solenoid is energized.

FIG. 3A is a cutaway diagram of yet another embodiment of the disclosed apparatus for limiting the movement of an armature of a solenoid, in the form of a multiple solenoid multiple port valve controller, shown when the solenoids are not energized.

FIG. 3B is a cutaway diagram of the controller of FIG. 3A, shown when a solenoid is energized.

FIG. 4 is a flowchart of the disclosed method for limiting the movement of an armature of a solenoid.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, numerous implementation-specific decisions must be made to achieve specific goals, such as compliance-related or business-related goals, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

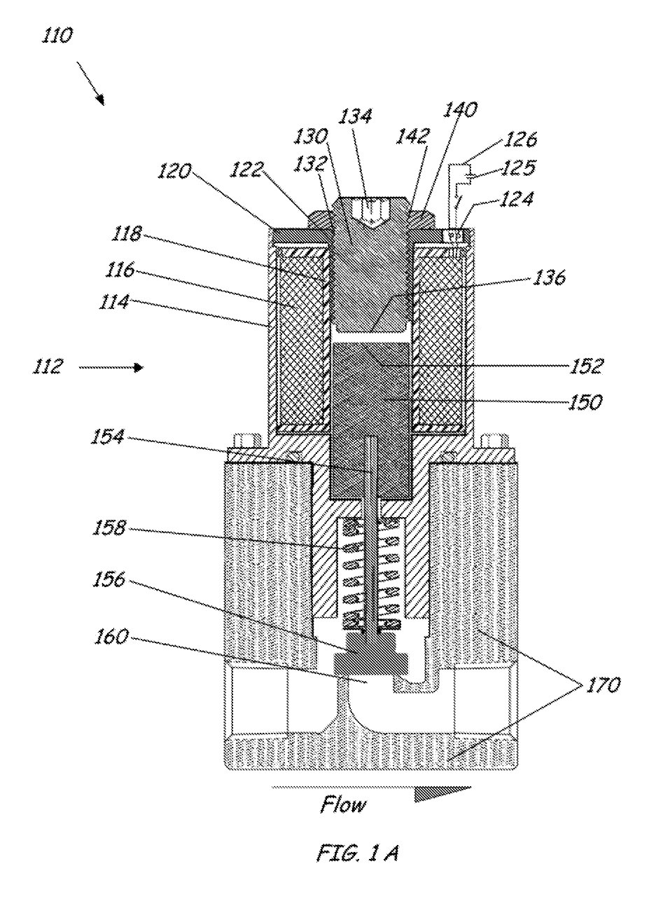

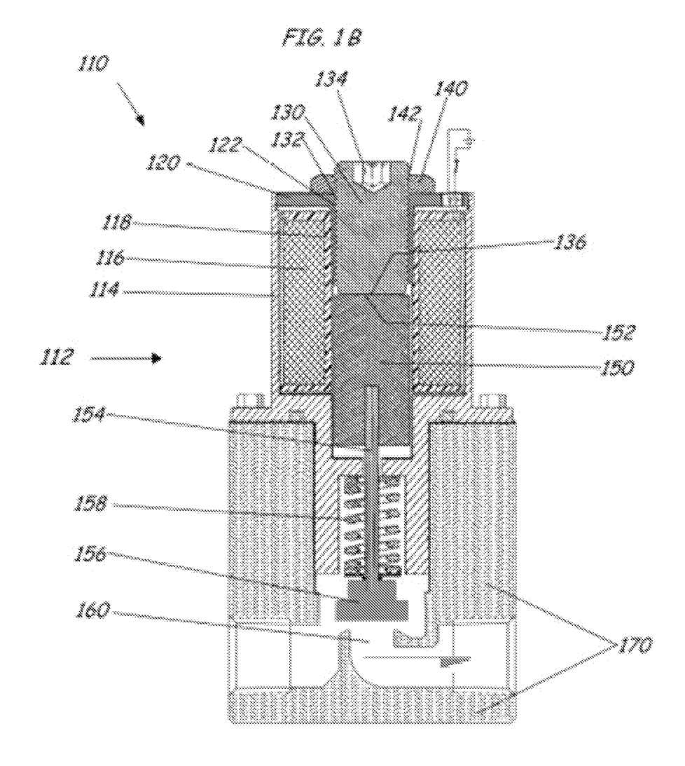

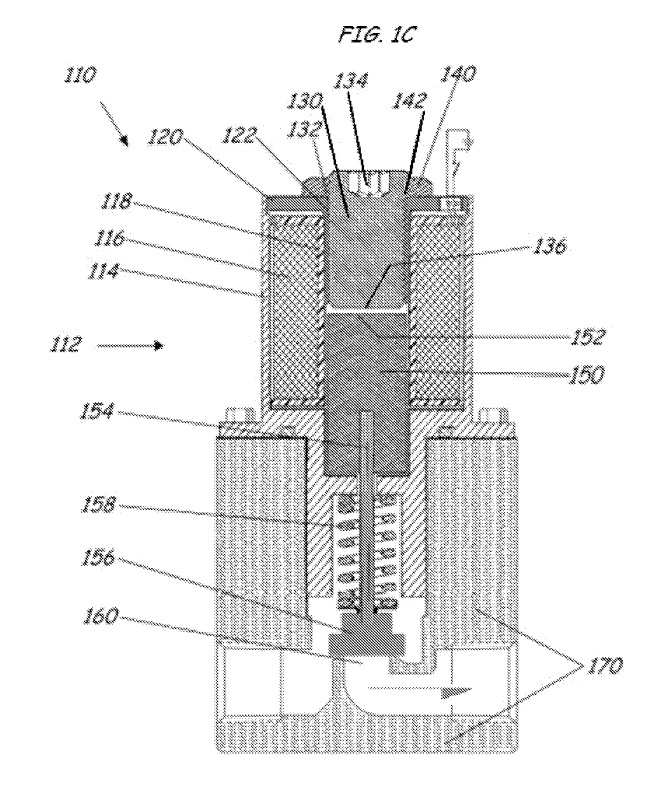

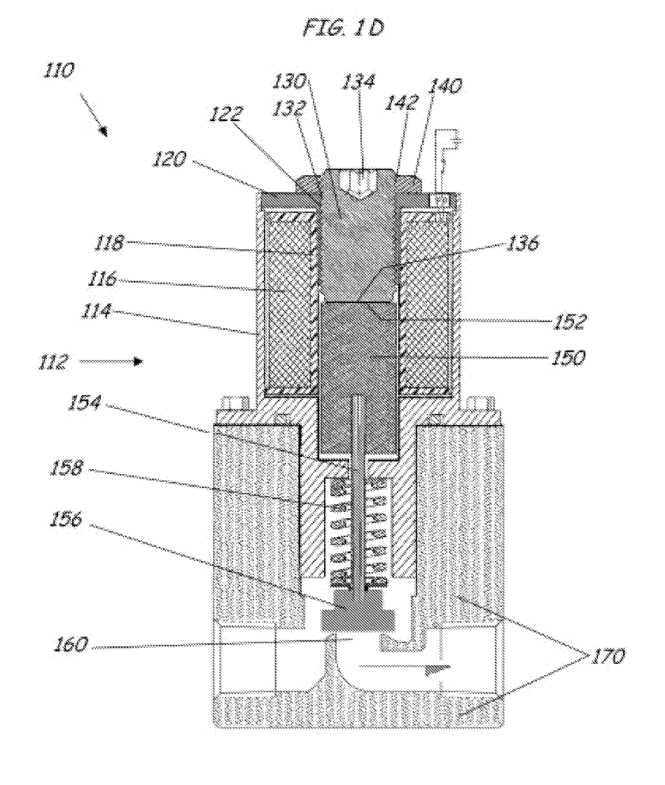

FIGS. 1A-1D are cutaway diagrams of a single solenoid single valve controller when: the solenoid is not energized and adjusted for higher flow (FIG. 1A), the solenoid is energized and adjusted for higher flow (FIG. 1B), the solenoid is not energized and adjusted for lower flow (FIG. 1C), and the solenoid is not energized and adjusted for lower flow (FIG. 1D), in accordance with the disclosure. Solenoid valve 110 comprises: a solenoid 112, a bushing 120, a stroke limiter 130, a fastener 140, an armature 150, a rod 154, a spring 158, a poppet 156, an opening 160, and a housing 170. The solenoid valve 110 controls a flow of liquid or gas.

The solenoid 112 comprises: an external casing 114, windings 116, and an internal casing 118. The solenoid 112 converts electrical energy, in the form of an electrical current passing through the windings 116, into linear motion of the armature 150. In so doing, the solenoid 112 moves the armature 150 in a first direction and compresses the spring 158 when the solenoid 112 is energized.

The external casing 114 shields the interior parts of the solenoid 112, e.g. the windings 116. The external casing 114 may also shield the outside environment from the electromagnetic fields generated via the windings 116 when electrical current passes through them.

The windings 116 generate a magnetic field when electrical current passes therethrough. This magnetic field causes the armature 150 to move toward the center of the windings 116 when it is sufficient to overcome the force provided by the spring 158. As depicted by FIGS. 1B and 1D, armature 150 moves toward the stroke limiter 130 at the top of the diagram when the solenoid 112 is energized by passing electrical current through the windings 116. The windings 116 may be made of any suitable material for handling electrical current, including a tightly wound coil of copper wire.

The internal casing 118 protects the windings 116 from the movement of the armature 150 within the solenoid 112. The internal casing 118 provides a smooth surface for the armature 150 to slide.

The bushing 120 is a threaded bushing comprising threads 122 and an opening 124. The bushing 120 couples the stroke limiter 130 to the inside of the solenoid 112. The bushing 120 protects the interior casing 118 of the solenoid 112 from the threads 132 of the stroke limiter 130. The bushing 120 provides threads 122 against which the threads 132 of the stroke limiter 130 may be tightened. The bushing 120 provides a surface against which a fastener in the form of a nut 140 contacts to secure the stroke limiter 130 in place. The opening 124 of the bushing 120 allows for an electric coupling between the windings 116 and an energy source 125, such as by one or more wires or other conductors 126.

The stroke limiter 130 comprises a surface comprising three portions. The first portion of the surface of the stroke limiter 130 comprises a contact surface 136, the second portion comprises threads 132, and the third portion comprises a drive hole 134. FIGS. 1A and 1B illustrate the stroke limiter 130 at a first position that is adjusted for higher flow through the solenoid valve 110. FIGS. 1C and 1D illustrate the stroke limiter 130 at a second position that is adjusted for lower flow through the solenoid valve 110. With the stroke limiter 130 the first position, the armature 150 can move closer towards the middle of the solenoid 120. With the second position, the armature 150 is prevented from moving as close to the center of the solenoid 120. Limiting the movement of the armature 150 limits the movement of the poppet 156 and limits the maximum amount of flow through the solenoid valve 110 that is allowed by energizing the windings 116 of the solenoid 120. The stroke limiter 130 controls the amount of flow through the solenoid valve 110 by limiting the movement of the poppet 156 via the armature 150. It will be apparent to one skilled in the art that the stroke limiter 130 is not limited to the first and second positions only. The stroke limiter may be adjusted literally to an infinite number of positions, each limiting the travel of the armature 150 to a different degree.

The contact surface 136 of the first portion of the surface of the stroke limiter 130 limits the movement of the armature 150 via contact between the contact surface 136 and the contact surface 152 of the armature 150. When the windings 116 are energized, movement of the armature 150 into the space between the windings 116 is limited by the position of the stroke limiter 130 when the surface 152 of the armature 150 contacts the surface 136 of the stroke limiter 130.

The threads 132 of the second portion of the surface of the stroke limiter 130 adjustably couple the stroke limiter 130 to the solenoid 112 thereby setting a stroke length of the armature 150. The threads 132 of the stroke limiter 130 contact the threads 122 of the thread bushing 120 to hold the stroke limiter 130 in place with respect to the solenoid 112.

The threads 132 of the second portion of the surface of the stroke limiter 130 releasably couple the stroke limiter 130 to the fastener 140. The threads 132 of the stroke limiter 130 engage the threads 142 of the nut 140 to prevent movement of the stroke limiter 130 relative to the bushing 120. This prevents movement of the stroke limiter 130 that can be caused by repeated contact between the contact surfaces 136 and 152 of the stroke limiter 130 and the armature 150.

The third portion of the surface of the stroke limiter 130 forms a drive hole 134 allowing for adjustment of a limiter position of the stroke limiter 130. Adjusting the limiter position controls the amount of flow through the valve by way of controlling the distance that the armature 150 may travel to open the connections between ports of the valve. The precision of the adjustments to the placement of the stroke limiter 130 within the solenoid 120, and thereby the limiter position and stroke length of the armature 150, is associated with the spacing between the threads 132. In embodiments where the threads 132 are more closely spaced, more precise adjustments can be made to the stroke limiter 130, limiter position, and stroke length.

The drive hole 134 is shaped to fit an adjusting member. Types of adjusting members include: an Allen wrench, a hex driver, a screwdriver, and the like.

The nut 140 includes threads 142. The nut 140 secures the stroke limiter 130 in place with respect to the solenoid 112 and bushing 120 and maintains the stroke length. The threads 142 of the nut 140, the threads 132 of the stroke limiter 130, and the contact between the nut 140 and the bushing 120 operate to pull the stroke limiter 130 out of the solenoid 112, which is resisted by the threads 132 of the stroke limiter 130 contacting with the threads 122 of the bushing 120.

The armature 150 includes a contact surface 152 and a cavity that receives an end of rod 154. The armature 150 moves in response to the energization of the solenoid 112. The embodiment depicted in FIGS. 1A-1D shows the armature 150 partially outside of the internal casing 118. When the windings 116 of the solenoid 112 are energized, the armature 150 is pulled towards the middle of the solenoid 112 until the armature 150 contacts the stroke limiter 130. As depicted in FIGS. 1A and 1C, the spring 158 operates to pull the armature 150 back out from the middle of the solenoid 112, such that when the solenoid 112 and its windings 116 are no longer energized, the spring 158 pulls the armature 150 out from the internal casing 118.

The rod 154 is connected at a first end to the armature 150 and is connected at a second end to a working portion of the rod, shown in the embodiment of FIGS. 1A-1D as the poppet 156. The rod 154 shares a central axis with the spring 158 and a washer between the spring 158 and the poppet 156. The rod 154 transfers motion of the armature 150 to the poppet 156 and transfers force from the spring 158 to the armature 150.

The spring 158 is within a cavity of the external casing 114 of the solenoid 112. The spring 158 repositions the rod 154 when the solenoid 112 is no longer energized so that the poppet 156 covers the opening 160 of housing 170. The spring 158 is compressed between the external casing 114 and a washer between the spring 158 and the poppet 156. The spring 158 provides a force proportional to its compression that is sufficient to pull the armature 150 away from the middle of the solenoid 112 when the solenoid is not energized, and hold the poppet 156 against opening 160 to close it.

The poppet 156 is at an end of the rod 154 and seals the opening 160. The poppet 156 prevents the flow of gas, liquid, or the like, from flowing through the solenoid valve 110 when pressed against the housing 170 due force from the spring 158 by closing opening 160. When the solenoid 112 is energized, the armature 150 is drawn into the coil 116, thereby compressing the spring 158 and moving the poppet 156 away from the housing 170, to open opening 160 and allow gas or fluid to flow through the opening.

The housing 170 comprises the passageways through which the gas or fluid flows. The housing 170 provides for the mounting of the external casing 114 of the solenoid 112 to keep the solenoid 112, armature 150, rod 154, and poppet 156 aligned with the opening 160.

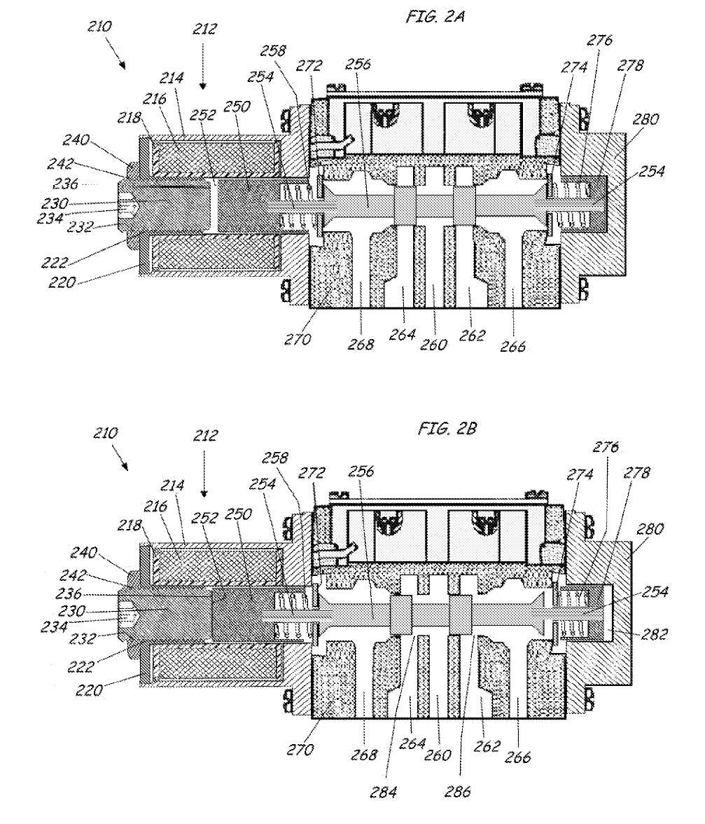

FIGS. 2A and 2B are a cutaway diagrams of a single solenoid multiple port valve controller when the solenoid 212 is not energized and when the solenoid 212 is energized, respectively. Solenoid valve 210 comprises: a solenoid 212; a bushing 220; a stroke limiter 230; a fastener 240; an armature 250; a rod 254; springs 258 and 276; a spindle 256; ports 260, 262, 264, 266, and 268; a housing 270, washers 272 and 274; return washer 278; and end cover 280. The solenoid valve 210 controls a flow of liquid or gas through the ports 260, 262, 264, 266, and 268.

The solenoid 212 comprises: an external casing 214, windings 216, and an internal casing 218. The solenoid 212 converts electrical energy, in the form of an electrical current passing through the windings 216 into linear motion of the armature 250. In so doing, the solenoid 212 moves the armature 250 in a first direction (to the left in FIGS. 2A and 2B) and compresses the spring 276 when the solenoid 212 is energized (see FIG. 2B).

The external casing 214 shields the interior parts of the solenoid 212, e.g. the windings 216. The external casing 214 may also shield the outside environment from the electromagnetic fields generated via the windings 216 when electrical current passes through them.

The windings 216 generate a magnetic field when electrical current passes through them. This magnetic field causes the armature 250 to move toward the center of the windings 216 when it is sufficient to overcome the force provided by the spring 276. As depicted by FIGS. 2A and 2B, armature 250 would move towards the left of the diagram towards the stroke limiter 230 when the solenoid 212 is energized by passing electrical current through the windings 216. The windings 216 may be made of any suitable material for handling electrical current, including a tightly wound coil of copper wire.

The internal casing 218 protects the windings 216 from the movement of the armature 250 within the solenoid 212. The internal casing 218 provides a smooth surface for the armature 250 to slide.

The bushing 220 is a threaded bushing comprising threads 222. The bushing 220 couples the stroke limiter 230 to the inside of the solenoid 212. The bushing 220 protects the internal casing 218 of the solenoid 212 from the threads 232 of the stroke limiter 230. The bushing 220 provides threads 222 against which the threads 232 of the stroke limiter 230 may be tightened. The bushing 220 provides a surface against which fastener 240 contacts to secure the stroke limiter 230 in place.

The stroke limiter 230 comprises a surface comprising three portions. The first portion of the surface of the stroke limiter 230 comprises a contact surface 236, the second portion comprises threads 232, and the third portion comprises a drive hole 234.

The contact surface 236 of the first portion of the surface of the stroke limiter 230 limits the movement of the armature 250 via contact between the contact surface 236 of the stroke limiter and the contact surface 252 of the armature 250. When the windings 216 are energized, movement of the armature 250 into the space between the windings 216 is limited by the position of the stroke limiter.

The threads 232 of the second portion of the surface of the stroke limiter 230 adjustably couple the stroke limiter 230 to the solenoid 212 thereby setting a stroke length of the armature 250. The threads 232 of the stroke limiter 230 contact the threads 222 of the bushing 220 to hold the stroke limiter 230 in place with respect to the solenoid 212.

The threads 232 of the second portion of the surface of the stroke limiter 230 releasably couple the stroke limiter 230 to a fastener, such as a nut 240. The threads 232 of the stroke limiter 230 contact the threads 242 of the nut 240 to secure the stroke limiter 230 to the bushing 220. This prevents movement of the stroke limiter 230 that can be caused by repeated contact between the contact surfaces 236 and 252 of the stroke limiter 230 and the armature 250.

The third portion of the surface of the stroke limiter 230 forms a drive hole 234 allowing for adjustment of a limiter position of the stroke limiter 230. Adjusting the limiter position controls the amount of flow through the valve housing 270 by way of controlling the distance that the armature 250 may travel to open the connections between ports of the valve. The precision of the adjustments to the placement of the stroke limiter 230 within the solenoid 220, and thereby the limiter position and stroke length of the armature 250, is associated with the spacing between the threads 232. In embodiments where the threads 232 are more closely spaced, more precise adjustments can be made to the stroke limiter 230, limiter position, and stroke length.

The drive hole 234 is shaped to fit an adjusting member. Types of adjusting members include: an Allen wrench, a hex driver, a screwdriver, and the like.

The nut 240 includes threads 242. The nut 240 and engagement of threads 222, 232 of the stroke limiter 230 and bushing 220 secure the stroke limiter 230 in place with respect to the solenoid 212 and maintains the stroke length. The threads 242 of the nut 240, the threads 232 of the stroke limiter 230, and the contact between the nut 240 and the bushing 220 operate to pull the stroke limiter 230 out of the solenoid 212, which resisted by the threads 232 of the stroke limiter 230 contacting with the threads 222 of the bushing 220.

The armature 250 includes a contact surface 252 and a cavity that receives rod 254. The armature 250 moves in response to the energization of the solenoid 212. The embodiment depicted in FIG. 2A shows the armature 250 displaced partially outside of the internal casing 218 by spring 276. When the windings 216 of the solenoid 212 are energized, the armature 250 is pulled toward the middle of the windings 216 until the armature 250 contacts the stroke limiter 230, as shown in FIG. 2B. The spring 276 operates to pull the armature 250 back out from the middle of the windings 216 when the solenoid 212 and its windings 216 are no longer energized.

The armature 250 is coupled to the rod 254. A cavity within the armature 250 receives an end of the rod 254. In so doing, movements of the armature 250 translate to movements of the rod 254.

The rod 254 is connected at a first portion to the armature 250; connected at a second portion to a working portion of the rod, shown in the embodiment of FIGS. 2A and 2B as the spindle 256, and is connected at a third portion to the return washer 278. The rod 254 shares a central axis with the springs 258 and 276, with the washers 272 and 274, and with the spindle 256. The rod 254 transfers motion of the armature 250 to the spindle 256 and transfers force from the springs 258 and 276 to the armature 250.

The spring 276 is within a cavity of the return washer 278. The spring 276 repositions the rod 254 when the solenoid 212 is no longer energized so that the spindle 256 covers the openings 284 and 286. The spring 276 is compressed between the return washer 278 and the washer 274, which is between the spring 276 and the spindle 256. The spring 276 provides a force proportional to its compression that is sufficient to pull the armature 150 away from the middle of the solenoid 112 when the solenoid 112 is not energized.

The spindle 256 is at a central portion of the rod 254 and, when centered in the housing 270 as shown in FIG. 2A, seals the openings between the ports 260, 262, 264, 266, and 268. The spindle 256 prevents the flow of gas, liquid, or the like, from flowing through the solenoid valve 210 when positioned against the housing 270 to close the openings 284 and 286 between the ports 260, 262, 264, 266, and 268. When the solenoid 212 is energized, the spindle 256 moves towards the solenoid 212 to create the openings 284 and 286 that allow gas or fluid to flow through the housing 270.

The housing 270 comprises the passageways through which the gas or fluid flows. The housing 270 provides for the mounting of the external casing 214 of the solenoid 212 and the end cover 280 to keep the solenoid 212, armature 250, rod 254, and spindle 256 properly aligned.

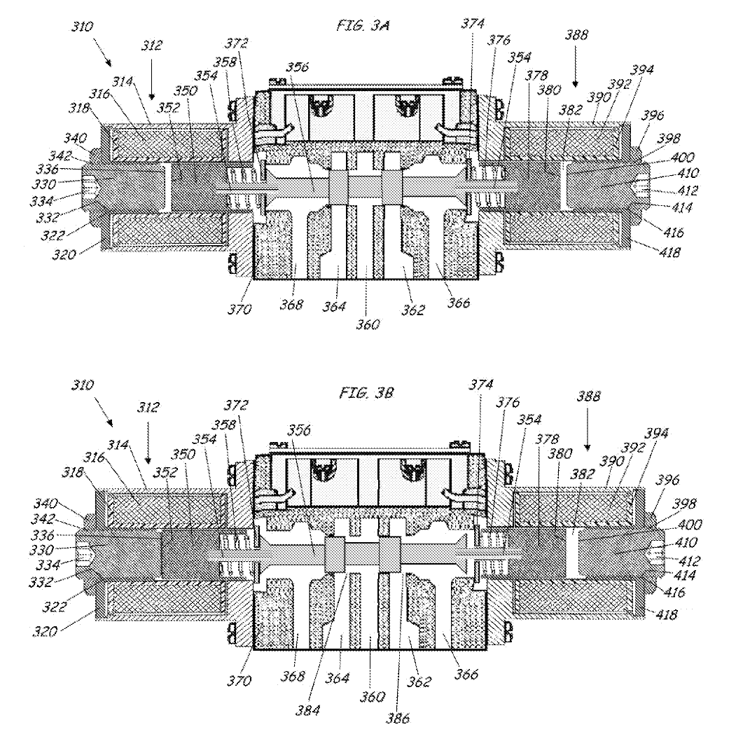

FIGS. 3A and 3B are cutaway diagrams of a multiple solenoid multiple port valve controller 310 when the solenoids 312 and 388 are not energized and when the solenoid 312 is energized, respectively. Solenoid valve 310 comprises: solenoids 312 and 388; bushings 320 and 418; stroke limiters 330 and 410; fasteners 340 and 396; armatures 350 and 378; a rod 354; springs 358 and 376; a spindle 356; ports 360, 362, 364, 366, and 368; a housing 370, and washers 372 and 374. The solenoid valve 310 controls a flow of liquid or gas through the ports 360, 362, 364, 366, and 368 of the housing 370.

The solenoid 312 comprises: an external casing 314, windings 316, and an internal casing 318. The solenoid 312 converts electrical energy, in the form of an electrical current passing through the windings 316, into linear motion of the armature 350. In so doing, the solenoid 312 moves the armature 350 in a first direction and compresses the spring 376 when the solenoid 312 is energized.

The external casing 314 shields the interior parts of the solenoid 312, e.g. the windings 316. The external casing 314 may also shield the outside environment from the electromagnetic fields generated via the windings 316 when electrical current passes therethrough.

The windings 316 generate a magnetic field when electrical current passes therethrough. This magnetic field causes the armature 350 to move toward the center of the windings 316 when it is sufficient to overcome the force provided by the spring 376. As depicted by FIGS. 3A and 3B, armature 350 would move towards the left of the diagram towards the stroke limiter 330 when the solenoid 312 is energized by passing electrical current through the windings 316. The windings 316 may be made of any suitable material for handling electrical current, including a tightly wound coil of copper wire.

The internal casing 318 protects the windings 316 from the movement of the armature 350 within the solenoid 312. The internal casing 318 provides a smooth surface for the armature 350 to slide.

The bushing 320 is a threaded bushing comprising threads 322. The bushing 320 couples the stroke limiter 330 to the inside of the solenoid 312. The bushing 320 protects the interior casing 318 of the solenoid 312 from the threads 332 of the stroke limiter 330. The bushing 320 provides threads 322 against which the threads 332 of the stroke limiter 330 may be tightened. The bushing 320 provides a surface against which a fastener, in the form of a nut 340, contacts to secure the stroke limiter 330 in place.

The stroke limiter 330 comprises a surface comprising three portions. The first portion of the surface of the stroke limiter 330 comprises a contact surface 336, the second portion comprises threads 332, and the third portion comprises a drive hole 334.

The contact surface 336 of the first portion of the surface of the stroke limiter 330 limits the movement of the armature 350 via contact between the contact surface and the contact surface 352 of the armature 350. When the windings 316 are energized, movement of the armature 350 into the space between the windings 316 is limited by the position of the stroke limiter 330 when the surface 352 of the armature contacts the surface 336 of the stroke limiter.

The threads 332 of the second portion of the surface of the stroke limiter 330 adjustably couple the stroke limiter 330 to the solenoid 312 thereby setting a stroke length of the armature 350. The threads 332 of the stroke limiter 330 contact the threads 322 of the bushing 320 to hold the stroke limiter 330 in place with respect to the solenoid 312.

The threads 332 of the second portion of the surface of the stroke limiter 330 adjustably couple the stroke limiter 330 to the nut 340. The threads 332 of the stroke limiter 330 contact the threads 342 of the nut 340 to secure the stroke limiter 330 to the bushing 320. This prevents movement of the stroke limiter 330 relative to the internal casing 318 that can be caused by repeated contact between the contact surfaces 336 and 352 of the stroke limiter 330 and the armature 350.

The third portion of the surface of the stroke limiter 330 forms a drive hole 334 allowing for adjustment of a limiter position of the stroke limiter 330. Adjusting the limiter position controls the amount of flow through the valve by way of controlling the distance that the armature 350 may travel to open the connections between ports of the valve. The precision of the adjustments to the placement of the stroke limiter 330 within the solenoid 320, and thereby the limiter position and stroke length of the armature 350, is associated with the spacing between the threads 332. In embodiments where the threads 332 are more closely spaced, more precise adjustments can be made to the stroke limiter 330, limiter position, and stroke length.

The drive hole 334 is shaped to fit an adjusting member. Types of adjusting members include: an Allen wrench, a hex driver, a screwdriver, and the like.

The fastener 340 includes threads 342. The fastener 340 secures the stroke limiter 330 in place with respect to the solenoid 312 and maintains the stroke length. The threads 342 of the fastener 340, the threads 332 of the stroke limiter 330, and the contact between the nut 340 and the bushing 320 operate to pull the stroke limiter 330 out of the internal casing 318, which resisted by the threads 332 of the stroke limiter 330 contacting with the threads 322 of the bushing 320.

The armature 350 includes a contact surface 352 and a cavity that receives an end of the rod 354. The armature 350 moves in response to the energization of the windings 316 of the solenoid 312. The embodiment depicted in FIG. 3A shows the armature 350 partially outside of the internal casing 318. When the windings 316 of the solenoid 312 are energized, the armature 350 is pulled towards the middle of the internal casing 318 and windings 316 until the armature 350 contacts the stroke limiter 330, as shown in FIG. 3B. The spring 376 operates to pull the armature 350 back out from the middle of the internal casing 318 when the windings 316 are no longer energized.

An end of the rod 354 is received within a cavity within the armature 350. In so doing, movements of the armature 350 translate to movements of the rod 354.

The rod 354 is connected at a first portion to the armature 350; connected at a second portion to a working portion of the rod 354, shown in the embodiment of FIGS. 3A and 3B as the spindle 356, and is connected at a third portion to the armature 378. The rod 354 shares a central axis with the springs 358 and 376, with the washers 372 and 374, and with the spindle 356. The rod 354 transfers motion of the armatures 350 and 378 to the spindle 356 and transfers force from the springs 358 and 376 to the armature 350.

The spring 358 is within a cavity of the armature 350 of the solenoid 312. The spring 358 repositions the rod 354 when the windings 392 of solenoid 388 are no longer energized so that the spindle 356 closes the openings 384 and 386 in the housing 370. The spring 358 is compressed between the armature 350 and the washer 372, which is between the spring 358 and the spindle 356. The spring 358 provides a force proportional to its compression. When the windings 392 of the solenoid 388 is are not energized, the forces from the springs 358 and 376 balance each other out and act to center the spindle 356 within the housing 370, as shown in FIG. 3A.

The spring 376 is within a cavity of the armature 378. The spring 376 repositions the rod 354 when the windings 316 of solenoid 312 are no longer energized so that the spindle 356 covers the openings 384 and 386. The spring 376 is compressed between the armature 378 and the washer 374, which is between the spring 376 and the spindle 356. The spring 376 provides a force proportional to its compression that is sufficient to pull the armature 350 away from the middle of the windings 316 and internal housing 318 of solenoid 312 when the solenoid 312 is not energized.

The spindle 356 is at a central portion of the rod 354 and seals the openings between the ports 360, 362, 364, 366, and 368. The spindle 356 prevents the flow of gas, liquid, or the like, from flowing through the housing 370 when positioned against the housing to close the openings 384 and 386 between the ports 360, 362, 364, 366, and 368. When the solenoid 312 is energized, as shown in FIG. 3B, the spindle 356 moves toward the solenoid 312. This movement creates the openings 284 and 286 that allow gas or fluid to flow through solenoid valve 310.

The solenoid 388 comprises: an external casing 390, windings 392, and an internal casing 394. The solenoid 388 converts electrical energy, in the form of an electrical current passing through the windings 392, into linear motion of the armature 378. In so doing, the solenoid 388 moves the armature 378 in a first direction and compresses the spring 358 when the solenoid 388 is energized.

The external casing 390 shields the interior parts of the solenoid 388, e.g. the windings 392. The external casing 390 may also shield the outside environment from the electromagnetic fields generated via the windings 392 when electrical current passes therethrough.

The windings 392 generate a magnetic field when electrical current passes therethrough. This magnetic field causes the armature 378 to move toward the center of the windings 392 when it is sufficient to overcome the force provided by the spring 358. As depicted by FIGS. 3A and 3B, armature 378 would move towards the right of the diagram towards the stroke limiter 410 when the solenoid 388 is energized by passing electrical current through the windings 392. The windings 392 may be made of any suitable material for handling electrical current, including a tightly wound coil of copper wire.

The internal casing 394 protects the windings 392 from the movement of the armature 378 within the solenoid 388. The internal casing 394 provides a smooth surface for the armature 378 to slide.

The bushing 418 is a threaded bushing comprising threads 416. The bushing 418 couples the stroke limiter 410 to the inside of the solenoid 388. The bushing 418 protects the interior casing 394 of the solenoid 388 from the threads 414 of the stroke limiter 410. The bushing 418 provides threads 416 against which the threads 414 of the stroke limiter 410 may be tightened. The bushing 418 provides a surface against which fastener, such as nut 396, contacts to secure the stroke limiter 410 in place.

The stroke limiter 410 comprises a surface comprising three portions. The first portion of the surface of the stroke limiter 410 comprises a contact surface 400, the second portion comprises threads 414, and the third portion comprises a drive hole 412.

The contact surface 400 of the first portion of the surface of the stroke limiter 410 limits the movement of the armature 378 via contact between the contact surface 400 and the contact surface 380 of the armature 378 when the windings 392 are energized.

The threads 414 of the second portion of the surface of the stroke limiter 410 adjustably couple the stroke limiter 410 to the internal casing 394 of the solenoid 388 thereby setting a stroke length of the armature 378. The threads 414 of the stroke limiter 410 contact the threads 416 of the bushing 418 to hold the stroke limiter 410 in place with respect to the solenoid 388.

The threads 414 of the second portion of the surface of the stroke limiter 410 releasably couple the stroke limiter 410 to the nut 396 to secure the stroke limiter to the bushing 418. This prevents movement of the stroke limiter 410 that can be caused by repeated contact between the contact surfaces 400 and 380 of the stroke limiter 410 and the armature 378.

The third portion of the surface of the stroke limiter 410 forms a drive hole 412 allowing for adjustment of a limiter position of the stroke limiter 410. Adjusting the limiter position controls the amount of flow through the valve housing 370 by way of controlling the distance that the armature 378 may travel to open the connections between ports of the valve. The precision of the adjustments to the placement of the stroke limiter 410 within the internal casing 394 of the solenoid 388, and thereby the limiter position and stroke length of the armature 378, is associated with the spacing between the threads 414. In embodiments where the threads 414 are more closely spaced, more precise adjustments can be made to the stroke limiter 410, limiter position, and stroke length.

The drive hole 412 is shaped to fit an adjusting member. Types of adjusting members include: an Allen wrench, a hex driver, a screwdriver, and the like.

The nut 396 includes threads 398. The nut 396 secures the stroke limiter 410 in place with respect to the solenoid 388 and maintains the stroke length. The threads 398 of the nut 396, the threads 414 of the stroke limiter 410, and the contact between the nut 396 and the bushing 418 operate to pull the stroke limiter 410 out of the solenoid 388, which is resisted by the threads 414 of the stroke limiter 410 contacting with the threads 416 of the bushing 418.

The armature 378 includes a contact surface 380 and a cavity that receives the for rod 354. The armature 378 moves in response to the energization of the solenoid 388. The embodiment depicted in FIG. 3A shows the armature 378 partially outside of the internal casing 394 and windings 392 of the solenoid 388. When the windings 392 of the solenoid 388 are energized, the armature 378 is pulled towards the middle of the internal casing 394 and windings 392 until the armature 378 contacts the stroke limiter 410. The spring 358 operates to pull the armature 378 back out from the middle of the casing 394 when the solenoid 388 and its windings 392 are no longer energized.

The armature 378 receives the rod 354 within a cavity. In so doing, movements of the armature 378 translate to movements of the rod 354.

The housing 370 comprises the passageways through which the gas or fluid flows. The housing 370 provides for the mounting of the external casings 314 and 390 of the solenoids 312 and 388 to keep the solenoids 312 and 388, armatures 350 and 378, rod 354, and spindle 356 properly aligned.

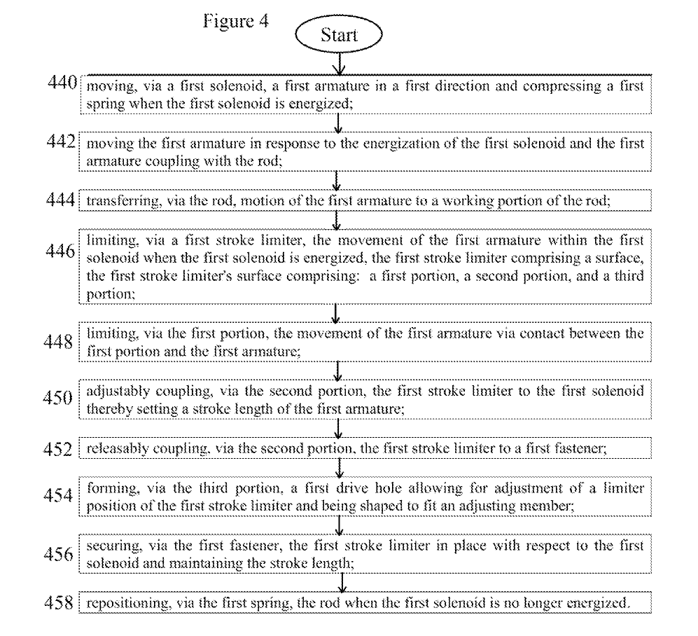

FIG. 4 is a flowchart of a method for limiting the movement an armature of a solenoid. A stop limiter provides a way to adjustably limit movement of the armature within the solenoid.

At 440, the method includes energizing a first solenoid and moving, via the first solenoid, a first armature in a first direction and compressing, via the movement of the armature, a first spring. The force of the first solenoid is great enough to overcome the force provided by the first spring, move the armature, and further compress the spring.

At 442, the method includes coupling the first armature with a rod. Embodiments with a single solenoid create reciprocal motion by the solenoid pulling on the armature when energized and one or more springs repositioning the armature when the solenoid is no longer energized.

Embodiments with two solenoids create reciprocal motion by a first solenoid pulling on the armature and the rod it is connected to when energized, a second solenoid pulling on a second armature and the rod in a different direction, and one or more springs acting to dampen or attenuate the motion created by the changing energizations of the solenoids, and to center a spindle within a valve housing when the first and second solenoids are not engergized.

At 444, the method includes transferring, via the rod, motion of the first armature to a working portion of the rod. The rod connects to the moving portion of the solenoid, the armature, to the moving portion of the valve.

At 446, the method includes limiting, via a first stroke limiter, the movement of the first armature within the first solenoid when the first solenoid is energized. The first stroke limiter comprises a surface comprising: a first portion, a second portion, and a third portion. In an embodiment, the method also may include adjusting a stroke limiter to adjust a distance of travel of the armature to a preset distance, thereby adjusting the amount the solenoid will open the associated valve when energized.

At 448, the method includes limiting, via the first portion, the movement of the first armature via contact between the first portion and the first armature. At 450, the method includes adjustably coupling, via the second portion, the first stroke limiter to the internal and/or external casing of the first solenoid thereby setting a stroke length of the first armature. At 452, the method includes releasably coupling, via the second portion, the first stroke limiter to a first fastener. At 454, the method includes forming, via the third portion, a first drive hole allowing for adjustment of a limiter position of the first stroke limiter and being shaped to fit an adjusting member.

At 456, the method includes securing, via the first fastener, the first stroke limiter in place with respect to the first solenoid and maintaining the stroke length. While the position of the stop limiter is adjustable, the fastener prevents unwanted movement of the stop limiter, which may be caused by operation of the solenoid valve.

At 458, the method includes repositioning, via the first spring, the rod when the first solenoid is no longer energized. Embodiments with more than one spring may have such springs act in opposition to each other to dampen or attenuate motion of the rod caused by changing the state of energization of the solenoid.

This written description and the several drawings use examples to disclose the invention and also to enable any person skilled in the art to practice the invention, including making and using any devices or systems and performing any incorporated methods. The patentable scope of the invention is defined by the claims and not by the written description and not by the drawings. The patentable scope may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An apparatus for limiting the movement of an armature of a solenoid moving a rod, the apparatus comprising:
a first solenoid having a first casing and first windings positioned within the first casing;
a first armature within the first solenoid and movable in a first direction toward a center of the windings when the first solenoid is energized;
a first rod attached to the first armature;
one of a poppet and a spindle attached to the rod and configured to engage an opening in a valve such that the first armature moves the one of a poppet and a spindle away from the opening when energized;
a first spring configured to urge the first armature in a direction away from the center of the first windings such that the rod moves the one of a poppet and a spindle to engage the opening; and
a first stroke limiter adjustably positionable relative to the first windings and configured to engage the first armature, whereby travel of the first armature toward the center of the windings in response to energizing the windings can be varied to limit travel of the first armature and the one of a poppet and a spindle from the opening to a preset distance.

2. The apparatus of claim 1, wherein the rod extends through the first spring.

3. The apparatus of claim 1, wherein the first stroke limiter is adjustably coupled the first solenoid.

4. The apparatus of claim 3, further comprising a first bushing configured to adjustably couple the first stroke limiter to the casing.

5. The apparatus of claim 1, further comprising an end cover adapted to engage an associated valve housing, wherein the first spring is received within the end cover.

6. The apparatus of claim 5, further comprising a return washer slidably received within the end cover, the first spring seated within the return washer.

7. The apparatus of claim 6, further comprising a washer seated against the valve housing, the first spring configured to urge against the washer.

8. An apparatus for limiting the movement of an armature of a solenoid moving a rod, the apparatus comprising:
a first solenoid having a first casing and first windings positioned within the first casing;
a first armature within the first solenoid and movable in a first direction toward a center of the first windings when the first solenoid is energized;
a first rod attached to the first armature;
a second solenoid having a second casing and second windings;
a second armature within the second solenoid and movable in a second direction toward a center of the second windings when the second solenoid is energized;
a second rod attached to the second armature;
a spindle attached to the first and second rods and configured to engage an opening in a valve such that the first armature moves the spindle in a first direction when the first windings are energized, and the second armature moves the spindle in a second direction when the second windings are energized;
a first stroke limiter adjustably positionable relative to the first windings and configured to engage the first armature, whereby travel of the first armature toward the center of the first windings in response to energizing the first windings can be varied to limit travel of the first armature and the spindle from the opening to a preset distance; and
a second stroke limiter adjustably positionable relative to the second windings and configured to engage the second armature, whereby travel of the second armature toward the center of the second windings in response to energizing the second windings can be varied to limit travel of the second armature and the spindle from the opening to a preset distance.

9. The apparatus of claim 8, further comprising:
a spring configured to position the spindle when the first and second solenoids are not energized.

10. The apparatus of claim 9, further comprising a first washer and a second washer seated on the spindle; and the spring includes a first spring urging the first washer against the spindle, and a second spring urging the second washer against the spindle.

11. A method for moving a rod, the method comprising:
providing a first solenoid configured to displace a first armature connected to a first rod in a first direction energized;
connecting one of a poppet and a spindle to the rod, to engage an opening in a valve in response to displacement of the armature;
adjusting a first stroke limiter to limit movement of the first armature within the first solenoid to a first preset distance when the first solenoid is energized; and
energizing the first solenoid to displace the first armature the first preset distance within the first solenoid, thereby displacing the one of the poppet and the spindle relative to the opening in the valve.

12. The method of claim 11, wherein energizing the first solenoid includes displacing the first armature to compress a spring.

13. The method of claim 11, further comprising positioning the first stroke limiter inside a winding of the first solenoid.

14. The method of claim 11, further comprising coupling, via a bushing, the stroke limiter to the first solenoid.

15. The method of claim 11, further comprising repositioning, via a spring, the rod when the first solenoid is not energized.

16. The method of claim 15, further comprising providing a spring on the rod between the armature and the one of the poppet and the spindle.

17. The method of claim 16, further comprising locking the stroke limiter to the solenoid to limit movement of the armature the preset distance.

18. The method of claim 15, further comprising:
providing a second solenoid, configured to displace a second armature connected to a second rod in a second direction when the second solenoid is energized;
adjusting a second stroke limiter to limit the movement of the second armature within the second solenoid to a second preset distance when the second solenoid is energized; and
energizing the second solenoid to displace the second armature the second preset distance within the second solenoid, thereby displacing the one of the poppet and the spindle relative to the opening in the valve.

19. The method of claim 18, further comprising:
locking the second stroke limiter to the second solenoid to limit movement of the second armature the second preset distance.

20. The method of claim 19, further comprising:
selectively energizing either the first or the second solenoid to position the one spindle.
